(19) United States
(12) Patent Application Publication
(10) Pub. No.: US 2014/0258297 A1
(43) Pub. Date: Sep. 11, 2014

(54) Automatic grouping of photos into folders and naming the photo folders

(71) Applicant: Shahram Davari, Los Altos, CA (US)

(72) Inventor: Shahram Davari, Los Altos, CA (US)

(21) Appl. No.: 13/815,486

(22) Filed: Mar. 7, 2013

(51) Int. Cl. G06F 17/30

(52) U.S. Cl. CPC G06F 17/30598
USPC 707/737

(57) ABSTRACT

This invention provides intelligent automatic grouping of photos. This is done by recognizing multiple photos taken from the same scene and grouping them together and displaying only one of the photos (auto-selected photo) from the group as the top-most visible photo on the screen. The user can see other photos from the same scene by placing curser or clicking on the auto-selected photo from the group. The device can automatically propose the best photo from the group and suggest photos that can be deleted from the group. This invention also provides another feature. Based on Time and date, GPS location information, contacts address, events (such as Birthday, Christmas, Valentine), etc. the device automatically groups the photos in a folder and provides the proper name for it such as “Valentine 2013 in Los Angeles”, or “John's birthday”.

### BACKGROUND OF THE INVENTION

In today's digital age, almost all cameras take digital photo or video. More importantly mobile phones and tablets have cameras that can take photo or video. Due to ease of use and large storage capacity in these digital devices, people tend to take many photos/shots from the same scene with the hope that one of them to be the perfect shot. However, this creates a large number of files in the camera, mobile device or tablet which needs to be reviewed and managed by user. The unwanted or bad photos needs to be selected and deleted, while the good photos needs to be kept and be grouped together in proper folder with proper name. All of this post processing functions are time consuming and tedious. In majority of cases the users just keep all the pictures unorganized in a single folder, which requires many times more storage as well as not being able to easily find pictures that are required in the future.

There has been some attempt to help organize the photos/videos. For example there are solutions that automatically group pictures in a folder based on the GPS location that the photos/videos are taken. But either the folder is created with some arbitrary name such as DCM1 or a date such as Jan. 10, 2013, or the user has to manually create the folder and its name, before taking the first picture in a specific event. All these methods are undesirable since either the name doesn't tell you much about the pictures in that folder or requires user intervention that is usually not convenient. In addition there are no solutions in the market that can automatically handle multiple photo shots from the same scene, show only one of them (possibly best photo) as the top-most visible photo and hide the rest of them in a folder under the top photo.

### SUMMARY OF THE INVENTION

This invention provides intelligent automatic grouping of the pictures/videos which reduces the user intervention and saves time and storage space. This is done by recognizing multiple photos taken from the same scene and grouping them together and displaying only one of the photos (auto-selected photo) from the group as the top-most visible photo on the screen. The user can see other photos from the same scene by placing curser or clicking on the auto-selected photo from the group. The device can automatically propose the best photo from the group and suggest photos that can be deleted from the group and possibly delete them automatically.

This invention also provides another feature. Based on Time and date, GPS location information, contacts address, events (such as Birthday, Christmas, Valentine), etc. the device automatically groups the photos in folders and provides the proper name for them such as “Valentine 2013 in Los Angeles”, or “John's birthday”.

### BRIEF DESCRIPTION OF THE DRAWINGS

FIG. 1 is a flow chart for grouping multiple photos taken from the same scene in very short period of time in to a Transparent folder. The grouping criteria is that the GPS location should be identical for all the photos in the group, the timing difference should be less than a configurable period (such as a few seconds), and the photos should show the same scene with minor variations.

FIG. 2 is similar to FIG. 1, with the exception that FIG. 2 creates the Transparent folder and grouping in to that folder, while the photos are being taken by the camera.

FIG. 3 is a flow chart of how the best photo in a Transparent folder can be selected manually or automatically to represent the rest of the photos in that folder. It also shows how the rest of the photos may be automatically or manually deleted or be marked for deletion.

FIG. 4 is a flow chart that shows how photos from the same event (such as a birthday party or a trip to Eiffel tower) can be grouped into a folder. The criteria for grouping is that the GPS location of all photos should be within a pre-configured range (X, Y) and the time difference between photos in the group should be within a configurable period (T).

FIG. 5 is a flow chart that automatically suggests a name for folders created in FIG. 4. The naming is automatic and is based on many data-base information such as GPS location of well-known public places (such as Eiffel Tower) stored in the user's camera/device/phone or retrieved from Internet/Cloud; GPS location of Contacts based on information stored in user's Contact's address book (such as address of a friend); Well-known dates (Such as New year or Valentine); or special dates in User's Calendar (such as Birthday, Anniversary, etc.) stored in the user's camera/device/phone or retrieved from Internet/Cloud; and the date and time the photo is taken.

### DETAILED DESCRIPTION OF THE PREFERRED EMBODIMENTS

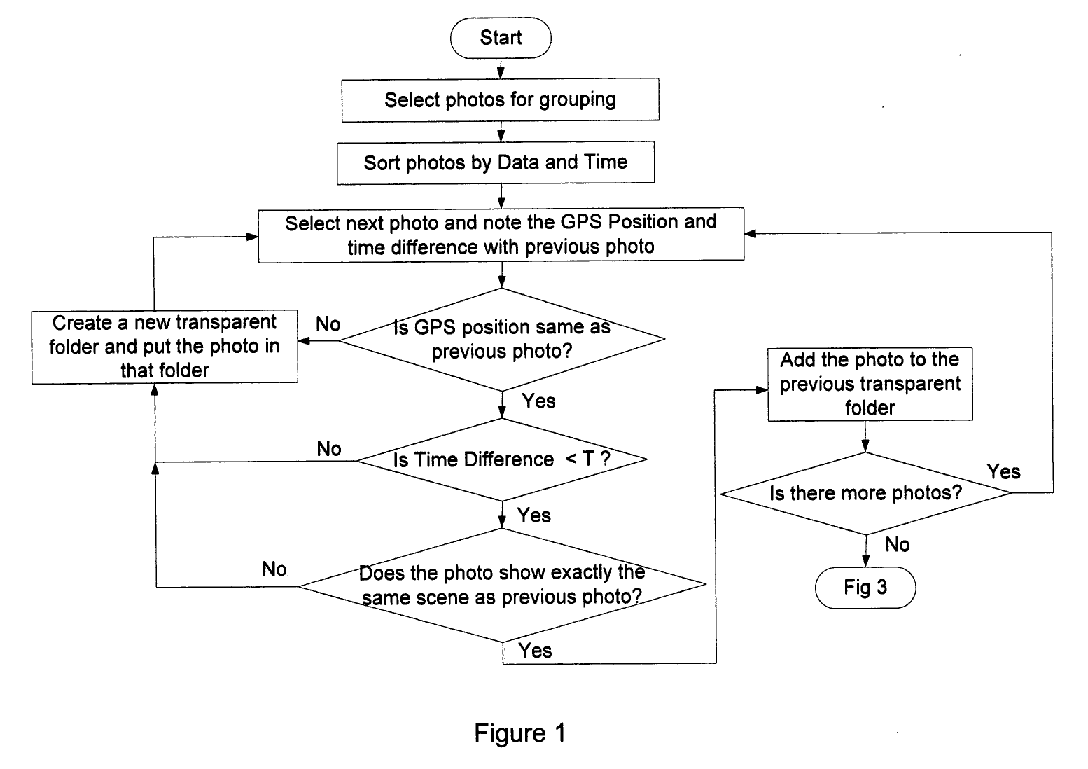

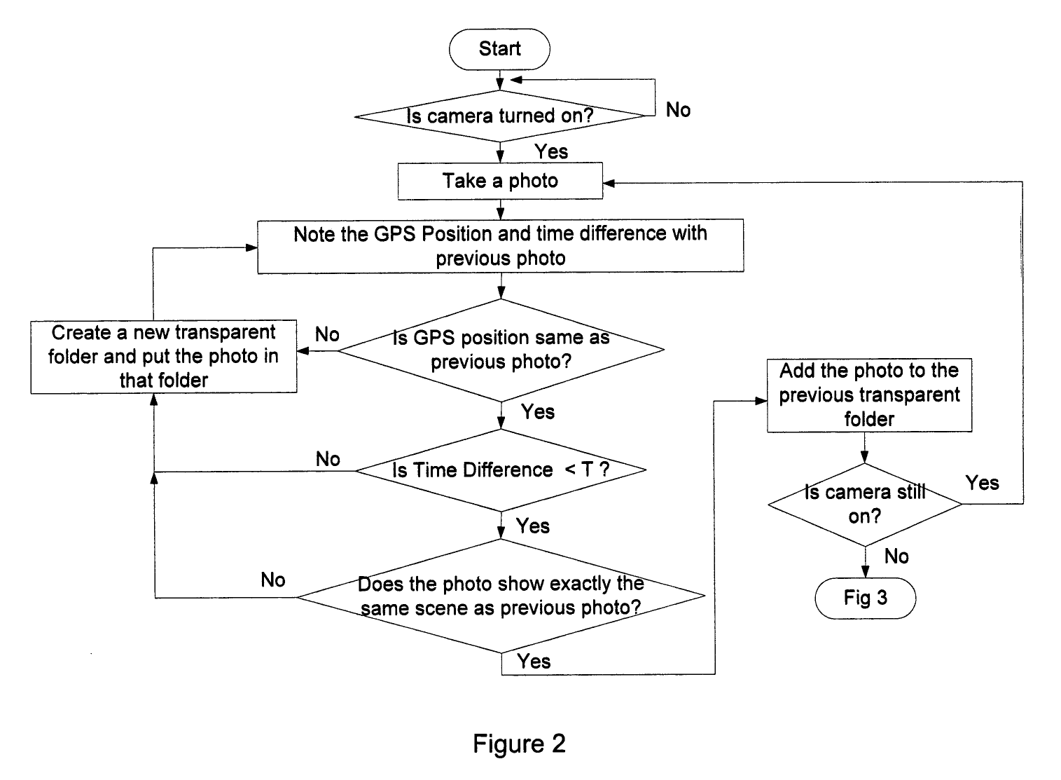

1) One embodiment of this invention is to group photos that similar in to Transparent folder. Multiple photos, which are taken from the same scene in a short period of time, such as in a few seconds apart, can be grouped together. This can be done based on the Time, GPS location as well as the similarities between those pictures, which require simple pattern recognition. As shown in FIG. 1, the photos in a camera or computer are sorted by date and time. Then photos that have the same GPS location and are taken within the same short interval “T” and are analyzed to see whether they are taken from the same scene. This can be done by pattern recognition and other image processing means. Photos that fulfill all the three conditions are grouped in the same Transparent folder. The same process can also be applied in real time while taking pictures as shown in FIG. 2. In this case each photo is compared to its previous photo.

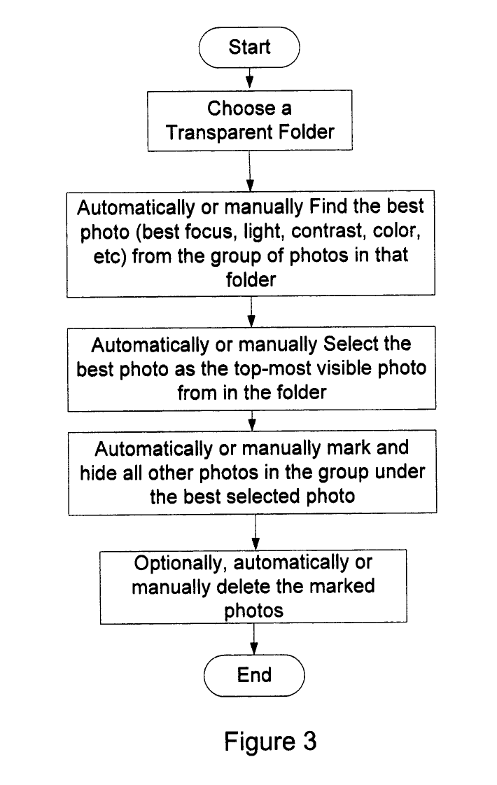

2) Another embodiment of this invention is that after the Transparent folders are created, the best photo in each Transparent folder could be selected manually by user or automatically by the system via software and/or hardware as shown in FIG. 3. Best photo may mean best focus, contrast, light, color, etc. Other photos in the Transparent folder, called bad photos, can then be hidden under the best photo. This would reduce the amount of visible photos by a user and therefore greatly enhances the time required to view photos and emnhances user experience and enjoyment of watching the photos. The bad photos can be tagged manually or automatically for deletion. As shown in FIG. 3, a user can optionally delete bad photos in a Transparent folder either manually or automatically. This would greatly reduce the amount of storage required for the photos and can also speed up the viewing time.

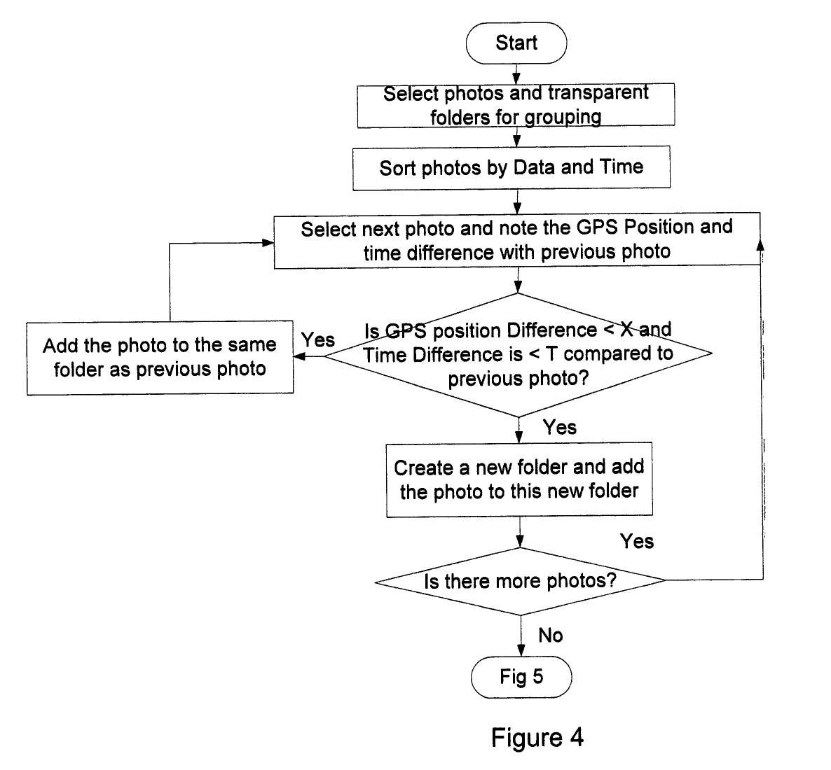

3) Another embodiment of this invention is to group photos or Transparent folders in Event folders. For example a group of photos taken at a friend's birthday party can be grouped together to create a “John's birthday” folder or the photos taken during a trip to Eiffel tower can be grouped together to create “Eiffel Tower Trip” folder. FIG. 4 shows how the grouping works. Basically the photos are sorted based on date and time. Photos that have almost the same GPS location, and have been taken within a configurable period of time (T) are grouped together in the same Event folder. Almost the same GPS location means that the difference between GPS Latitude and Longitude of the photos are within a configurable bound (X, Y).

The time period “T” and the GPS bounds “(X, Y)” can be configured manually or automatically. One way to automatically configure these parameters is to compare the GPS location of the photos to the user's Home GPS location, which can be stored as Home address in the camera or mobile phone's contacts or retrieved via Internet. If the GPS location of the photos is very far from the Home location, such as a different country than the home country or a different city than the home city, then (X, Y) can be automatically configured to accommodate the size of that country or city. For example the photos taken by a person who lives in San Jose, Calif. and travels to Paris can be grouped in a folder called “Paris Photo” and the system can automatically decide which GPS locations are within Paris limit.

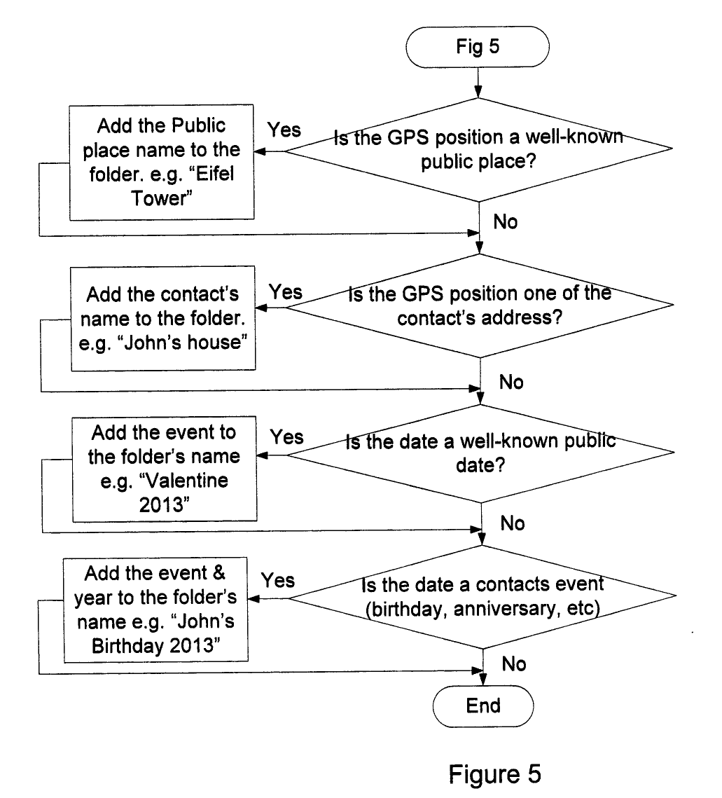

4) Another embodiment of this invention is to name the folders that were created in step (3) using the procedures shown in FIG. 5. The idea is to compare the GPS location of the pictures with well-known GPS locations such as “Eiffel Tower”, “Lake Tahoe”, etc. As well as with contacts' GPS location such as a friend's or relative's home address. Also compare the date the photos are taken to a public-event such as “Valentine”, “Father's day”, “Christmas”, etc. and compare to dates in the user's contact/calendar such as “Birthday”, “Anniversary”, etc. Then create a name that includes the location and/or the time of the photos such as “Christmas 2012” or “John's Birthday 2012 in Paris” or “Eiffel Tower trip May 2012”.

Any variations of the above teaching are also intended to be covered by this patent application.

1. A system for grouping multiple photos. Said system comprising:
a Central Processing Unit (CPU); and
a memory device;
a user;
wherein said memory device stores photos;
wherein said photos have timestamp that indicates date and time that said photos were taken;
wherein said photos have GPS location stamp that indicates the location that said photos were taken;
wherein is said CPU sorts said photos by said timestamp;
wherein said user interacts with said CPU.

2. A system as in claim 1; wherein said CPU selects first group of photos from said photos and puts them in a first Transparent folder; wherein said timestamps of said first group of photos are within a first time period.

3. A system as in claim 2; wherein said CPU selects second group of photos from said first group of photos; wherein GPS location stamp of said second group of photos are identical.

4. A system as in claim 3; wherein said CPU selects third group of photos from said second group of photos; wherein said third group of photos are taken from a first scene and all elements of said first scene of said third group of photos are the same.

5. A system as in claim 4; wherein best photo from said third group of photos is selected based on best focus, contrast, color, light, white level and black level.

6. A system as in claim 5; wherein said best photo is selected automatically by said CPU or selected manually bay said user.

7. A system as in claim 5; wherein only said best photo is moved to the top of said Transparent folder and is shown as a single photo representing said third group of photos in said Transparent folder and hides rest of said third group of photos.

8. A system as in claim 7; wherein said rest of said third group of photos is marked as bad photos.

9. A system as in claim 8; wherein said bad photos can be deleted by said user or by said CPU.

10. A system as in claim 1; wherein said system exists inside a camera, mobile phone, tablet, Personal data assistant or computer.

11. A system as in claim 1; wherein said CPU selects fourth group of photos from said photos and puts them in first event folder; wherein said timestamps of said fourth group of photos are within a second time period.

12. A system as in claim 11; wherein said CPU selects said fourth group of photos from said photos; wherein said GPS location stamp of said fourth group of photos are within a first GPS range.

13. A system as in claim 11; wherein said second time interval and said first GPS range are configured manually by said user or set automatically by said CPU based on said GPS location stamp.

14. A system as in claim 12; wherein said CPU automatically selects a first name for said first event folder.

15. A system as in claim 14; wherein said GPS location stamp of said fourth group of photos belongs to a first well-known public place; wherein the GPS location of said first well-known public palace is stored in said memory device; wherein said CPU adds the name of said first well-known public place to said first name.

16. A system as in claim 14; wherein said GPS location stamp of said fourth group of photos belongs to address of first contact of said user; wherein said address of said first contact is stored in said memory device or retrieved from Internet; wherein said CPU adds the name of said first contact to said first name.

17. A system as in claim 14; wherein said timestamp of said fourth group of photos belongs to a first event; wherein said first event is a well-known public event; wherein said first event and its time are stored in said memory device or retrieved from Internet; wherein said CPU adds the name of said first event to said first name.

18. A system as in claim 14; wherein said timestamp of said fourth group of photos belongs to a second event; wherein said second event is a private event in said user's calendar; wherein said second event and its time are stored in said memory device or retrieved from Internet; wherein said CPU adds the name of said second event to said first name.
